(19) United States
(12) Patent Application Publication
(10) Pub. No.: US 2021/0284869 A1
(43) Pub. Date: Sep. 16, 2021

(54) METHOD FOR ADHERING PROFILES TO SUBSTRATE SURFACES

(71) Applicant: tesa SE, Norderstedt (DE)

(72) Inventors: Arne KOOPS, Neu-Lankau (DE); Martin GEELINK, Hamburg (DE)

(21) Appl. No.: 16/477,494

(22) PCT Filed: Jan. 8, 2018
(86) PCT No.: PCT/EP2018/050379

§ 371 Date: Jul. 11, 2019

(30) Foreign Application Priority Data
Jan. 12, 2017 (DE) 10 2017 200 471.1

(51) Int. Cl. C09J 5/02; C09J 7/38; C09J 133/10; B29C 65/50; B29C 65/48

(52) U.S. Cl. CPC C09J 5/02; C09J 7/385; B29C 65/4825; C09J 133/10; B29C 65/5057; C09J 7/383

(57) ABSTRACT

Provided are methods for adhesively bonding profiles to substrate surface. An example method includes plasma-treating each of a profile surface and a first adhesive side of a layer of pressure sensitive adhesive. The pressure sensitive adhesive includes a) 40 to 70 wt %, based on the total weight of the pressure sensitive adhesive, of at least one poly(meth)acrylate; b) 15 to 50 wt %, based on the total weight of the pressure sensitive adhesive, of at least one synthetic rubber; and c) at least one tackifier compatible with the poly(meth)acrylate(s). The method further includes bonding the profile surface and the first adhesive side to one another, plasma-treating a second adhesive side of the layer of the pressure sensitive adhesive, and bonding the plasma-treated second adhesive side to the substrate surface.

### TECHNICAL FIELD

The invention relates to a method for adhesively bonding profiles to substrate surfaces.

### BACKGROUND

In many areas of technology there is increasing use of adhesive tapes for the purpose of connecting components. In the particular case of adhesive bonds on surfaces of cars, a difficulty arises which results from the apolar nature of automobile component surfaces. The apolar surfaces are hydrophobic, so as to generate a particularly strong dirt and water repellency effect.

This, however, also has the disadvantage that adhesives customarily adhere poorly to the surfaces. High bonding strengths arising from polar substrates, such as on polyethylene or polypropylene surfaces, for example, are frequently very difficult if not possible to realize.

In the gluing of surfaces to one another by means of adhesives, a fundamental problem which exists is that of applying these adhesives durably and firmly to the surface of the substrate. It necessitates particularly high adhesion of the pressure sensitive adhesive on the surface.

Adhesion is commonly used to refer to the physical effect of holding together two phases that have been brought into contact with one another, at their interface, by means of intermolecular interactions that arise at said interface. The adhesion therefore determines the attachment of the adhesive on the substrate surface, which can be determined as tack and as peel adhesion force.

In order to exert a targeted influence on the adhesion of an adhesive, it is common to admix it with plasticizers and/or peel adhesion-boosting resins (referred to as “tackifiers”).

A simple definition of adhesion may be “the energy of interaction per unit area” [in mN/m]; this quantity cannot be measured, owing to experimental restrictions such as lack of knowledge as to the true contact areas. Often described, moreover, is the surface energy (SE), with “polar” and “apolar” components. This simplified model has become established in the art. This energy and the components thereof are oftentimes measured by measurement of the static contact angles of various test liquids. Polar and apolar components are assigned to the surface tensions of these liquids. The polar and apolar components of the surface energy of the surface under test are ascertained from the observed angles of contact of the droplets on the test surface. This may be done, for example, in accordance with the OWKR model. An alternative method, customary in industry, is that of determination by means of test inks in accordance with DIN ISO 8296.

In the context of such discussions, the terms “polar” and “high-energy” are often equated, as are the terms “apolar” and “low-energy”. The finding behind this is that polar dipole forces are comparatively strong, as compared with so-called “disperse” or “apolar” interactions, which are developed without participation of permanent molecular dipoles. The basis for this model of interface energy and interface interactions is the idea that polar components interact only with polar components, and apolar components only with apolar components.

However, a surface may also have small or moderate polar components within the surface energy, without the surface energy being “high”. As a guide, as soon as the polar component of the SE is greater than 3 mN/m, the surface is said for the purposes of this invention to be “polar”.

This corresponds approximately to the practical lower detection limit.

In principle there are no hard limits for terms such as high-energy and low-energy. For the purpose of the discussion, the limit is set at 38 mN/m or 38 dyn/cm (at room temperature). This is a level above which, for example, the printability of a surface is usually sufficient. For comparison, consideration may be given to the surface tension (=surface energy) of pure water, which is about 72 mN/m (dependent on factors including temperature).

Particularly on low-energy substrates such as PE, PP or EPDM, but also numerous paints, there are great problems in achieving satisfactory adhesion, not only when using pressure sensitive adhesives, but also other adhesives or coatings.

The physical pretreatment of substrates for the purpose of improving bond strengths is commonplace particularly with liquid reactive adhesives. A function of the physical pretreatment in this case may also be the cleaning of the substrate, removing oils, for example, or a roughening for the purpose of enlarging the effective area.

In the context of a physical pretreatment, the term usually used is that of “activation” of the surface. This normally implies an unspecific interaction, in contrast, for example, to a chemical reaction according to the lock-and-key principle. Activation generally implies an improvement in wettability, printability or anchorage of a coating.

In the case of self-adhesive tapes, the application of an adhesion promoter to the substrate is commonplace. Such application, however, is often a costly and inconvenient manual step that is prone to errors.

Success in the improvement of the adhesion of pressure sensitive adhesives by physical pretreatment of the substrate for example by flame treatment, corona treatment, plasma treatment, is not universal, since apolar adhesives, for example synthetic rubber, typically do not profit therefrom.

### SUMMARY OF THE INVENTION

It is an object of the invention, therefore, to provide a method allowing profiles to be bonded more effectively onto component surfaces.

The method of the invention is distinguished by the fact that a layer of pressure sensitive adhesive, which is specified in more detail later on below, is plasma-treated on a first adhesive side, and a profile surface of a profile is likewise plasma-treated, and the first adhesive side and the profile surface, both plasma-treated, are bonded to one another. Then a second adhesive side of the layer of pressure sensitive adhesive is likewise plasma-treated—the plasma treatment taking place may be the same or of a different kind relative to the plasma treatment of the first adhesive side—and the plasma-treated second adhesive side is bonded to the substrate surface.

A plasma treatment is described for example in EP 0 497 996 B1. Chosen there is a dual-pin electrode, with each of the pin electrodes having a channel of its own for pressurization.

Between the two tips of the electrodes, a corona discharge is produced which ionizes the stream of gas flowing through the channels and converts it into a plasma.

This plasma then reaches the surface to be treated, where its effect in particular is to perform a surface oxidation that enhances the wettability of the surface. The nature of the physical treatment is referred to (here) as indirect, because the treatment is not performed at the location where the electrical discharge is generated. The surface is treated at or near atmospheric pressure, but the pressure in the electrical discharge space or gas channel can be increased. The plasma here is an atmospheric pressure plasma, which is an electrically activated, homogeneous, reactive gas which is not in thermal equilibrium, having a pressure close to the ambient pressure in the zone of action. Generally speaking, the pressure is 0.5 bar more than the ambient pressure. As a result of the electrical discharges and as a result of ionization processes in the electrical field, the gas becomes activated, and highly excited states are generated in the gas constituents. The gas used and the gas mixture are referred to as process gas. In principle it is also possible for gaseous substances such as siloxane, acrylic acids or solvent, or other constituents, to be admixed to the process gas. Constituents of the atmospheric pressure plasma may be highly excited atomic states, highly excited molecular states, ions, electrons, and unaltered constituents of the process gas. The atmospheric pressure plasma is generated not in a vacuum, but instead usually in an air environment. This means that the outflowing plasma, if the process gas is not already itself air, contains at least constituents of the ambient air.

In the case of a corona discharge as defined above, the high voltage applied causes filamentary discharge channels with accelerated electrons and ions to be formed. The low-mass electrons in particular strike the surface at high velocity, with energies sufficient to break most of the molecular bonds. The reactivity of the reactive gas constituents also produced is usually a minor effect. The broken bond sites then react further with constituents of the air or of the process gas. A critical effect is the formation of short-chain degradation products through electron bombardment. Treatments of higher intensity are also accompanied by significant ablation of material.

The reaction of a plasma with the substrate surface intensifies the direct “incorporation” of the plasma constituents. Alternatively, on the surface, an excited state or an open bonding site and radicals may be produced, which then undergo further, secondary reaction, with atmospheric oxygen from the ambient air, for example. With certain gases such as noble gases, there is no likelihood of chemical bonding of the process gas atoms or molecules to the substrate. In this case the substrate is activated solely via secondary reactions.

The essential difference is therefore that in the case of the plasma treatment there is no direct exposure of the surface to discrete discharge channels. The effect therefore takes place homogeneously and non-aggressively, primarily by way of reactive gas constituents. In the case of an indirect plasma treatment, there are free electrons possibly present, but they are not accelerated, since the treatment takes place outside the generating electrical field.

The plasma treatment is therefore less destructive and more homogeneous than a corona treatment, since no discrete discharge channels impinge on the surface. Fewer short-chain degradation products of the treated material are formed; such products may form a layer with adverse effect on the surface. Consequently, it is often possible to achieve better wettabilities after plasma treatment by comparison with corona treatment, with longer-lasting effect.

The reduced extent of chain degradation and the homogeneous treatment by use of a plasma treatment make a substantial contribution to the robustness and effectiveness of the process taught.

The plasma device of EP 0 497 996 B1 features decidedly high gas flow rates in the region of 36 m³ per hour, with a 40 cm electrode width per gap. The high flow rates result in low residence time of the activated constituents on the surface of the substrate. Furthermore, the only plasma constituents reaching the substrate are those which are correspondingly long-lived and can be moved by a gas stream. Electrons, for example, cannot be moved by a gas stream, and therefore play no part.

A disadvantage with the stated plasma treatment, however, is the fact that the plasma impinging on the substrate surface has high temperatures of, in the most favorable case, at least 120° C. The resulting plasma, however, frequently possesses high temperatures of several 100° C. The known plasma cannons lead to high thermal entry into the substrate surface. The high temperatures may cause damage to the substrate surface, producing not only the activating products but also unwanted byproducts, which are known as LMWOMs, Low-Molecular-Weight Oxidized Materials. This highly oxidized and water-soluble polymer debris, which is no longer covalently bonded to the substrate, leads to a low level of resistance toward climatic conditions of heat plus humidity.

Besides the high-temperature plasma treatment it is also possible to pretreat the substrate surfaces in a low-temperature plasma treatment. Hence it is possible to treat the substrate surface of a substrate, prior to adhesive bonding, with a low-temperature plasma treatment and so to increase a peel adhesion force between the substrate surface and the adhesive surface of an adhesive.

By a low-temperature discharge configuration is meant, for example, a configuration which generally generates plasma of low temperature. In this case a process gas is conveyed into an electrical field, generated for example by a piezoelectric element, and is excited to a plasma. A plasma discharge space is the space within which the plasma is excited. The plasma emerges from an exit from the plasma discharge space.

A low-temperature plasma here refers to a plasma which has a temperature on striking the surface of at most 70° C., preferably at most 60° C., but more preferably at most 50° C. On account of the low temperature, the surfaces receive less damage, and, in particular, there is no formation of unwanted byproducts, the so-called LMWOMs (Low-Molecular-Weight Oxidized Materials). Particularly under ambient conditions of heat and humidity, these LMWOMs lead to a reduction in the peel adhesion force of the adhesive on the substrate surface.

The low temperature of the plasma has the advantage, moreover, that a plasma nozzle of the plasma generator can be run over the treating surface at a very small distance of less than 2 mm and this distance can be kept constant irrespective of the properties of the surface. As a result, in particular, the substrate surface can be activated at the same distance from the plasma nozzle as the adhesive surface, resulting in a marked acceleration of the method. Before now, when using high-temperature plasma nozzles, it was necessary to adapt the distance of the plasma nozzle exit from the surface of the substrate to each material. In accordance with the prior art, this is done by increasing or reducing the treatment distance from the material surface, respectively. Such variation, however, is associated with increased time consumption and with complication of the activation process.

The low-temperature plasma is generated favorably by a plasma nozzle which is based on a piezoelectric effect. In this case, a process gas is passed in front of a piezoelectric material in a plasma discharge space. The piezoelectric material as primary region is set in vibration via two electrodes by means of a low-volt alternating voltage. The vibrations are transmitted into the further, secondary region of the piezoelectric material. The opposite directions of polarization of the multilayer piezoceramic cause electrical fields to be generated. The potential differences that come about allow the generation of plasmas with low temperatures of at most 70° C., preferably 60° C., more preferably at most 50° C. There may be slight formation of heat only as a result of the mechanical work in the piezoceramic. In the case of common plasma nozzles with electric-arc-like discharges, this cannot be achieved, since the discharge temperature is above 900° C. for the excitation of the process gas.

Substrate surfaces used in accordance with the invention are LSE substrate surfaces such as Apo1.2 or HighSolid.

The LSE surfaces are low-energy viz. apolar surfaces in contrast to high-energy viz. polar surfaces. In principle, adhesive attaches more effectively to high-energy surfaces. In accordance with the invention, however, an adhesive bond is produced to low-energy surfaces. Low-energy surfaces have the advantage, though, that dirt, water, etc. also attach to them to a lesser degree. They are therefore highly suitable as paints, especially car paints.

The wettability of a surface is described by the surface energy. In this context, a drop of water is applied to the surface, and the contact angle of the water drop is measured. DIN 53364 or ASTM D 2578-84 discloses measurement methods for this. Apolar substrates are characterized in particular by a surface energy of less than 35 dyn/cm². The materials notable for LSE (low surface energy) surfaces include UV-curing paints, powder coatings and also polyolefins such as polypropylene (PP), high-pressure polyethylene (LDPE), low-pressure polyethylene (HDPE), ultrahigh molecular weight polyethylene (UHMWPE), and polymers of ethylene-propylene-diene monomer (EPDM).

A problem with the known plasma treatment of the substrate surfaces is the fact that it is relatively costly and inconvenient, requiring the entire component, the surface thereof, even if it only requires partial pretreatment, to be moved and to be supplied for an exact process operation.

It is now emerged, surprisingly, that peel adhesion forces both between profile surface and a first adhesive side of a layer of pressure sensitive adhesive are increased in the case of a plasma treatment on both sides, as are, too, the peel adhesion forces between a second adhesive side of the layer of pressure sensitive adhesive and a substrate surface, especially if that surface is an LSE substrate surface and if, preferably, only the other adhesive side is plasma-treated.

It has emerged that for certain layers of pressure sensitive adhesive (PSA), the peel adhesion force between the PSA layer and the LSE substrate surface can be increased if the surface of the PSA layer is plasma-treated.

The PSA layer comprises

a) 40 to 70 wt %, based on the total weight of the PSA, of at least one poly(meth)acrylate,

b) 15 to 50 wt %, based on the total weight of the PSA, of at least one synthetic rubber, and

c) at least one tackifier compatible with the poly(meth)acrylates. Firstly a PSA of this kind already exhibits a very good peel adhesion force not only at room temperature but also at −30° C. and +70° C.

In accordance with the invention, and as customary in the general linguistic usage, a pressure-sensitive adhesive (PSA) is understood to be a substance which at least at room temperature is durably tacky and also adhesive. Characteristic of a PSA is that it can be applied to a substrate by means of pressure, and remains adhering there, with the pressure to be employed and the exposure duration of that pressure not being defined in more detail. Generally speaking, though fundamentally dependent on the precise nature of the PSA and of the substrate, the temperature and the atmospheric humidity, a minimal pressure acting for a short time, which does not go beyond gentle contact for a brief moment, is sufficient to obtain the adhesion effect; in other cases, a longer-term duration of exposure to a higher pressure may also be necessary.

PSAs have particular, characteristic viscoelastic properties which result in the durable tack and adhesiveness. Characteristically, when PSAs are mechanically deformed, there are viscous flow processes and there is also development of elastic restorative forces. In terms of their respective proportion, the two processes are in a particular relationship with one another, dependent not only on the precise composition, structure and degree of crosslinking of the PSA but also on the rate and duration of the deformation, and on the temperature.

The proportional viscous flow is necessary for the achievement of adhesion. Only the viscous components, often produced by macromolecules with relatively high mobility, allow effective wetting and effective flow onto the substrate to be bonded. A high viscous flow component results in high pressure-sensitive adhesiveness (also referred to as tack or surface tackiness) and hence often also in a high peel adhesion. Owing to a lack of flowable components, highly crosslinked systems and polymers which are crystalline or which have undergone glasslike solidification generally have at least only a little tack, or none at all.

The proportional elastic restorative forces are necessary for the achievement of cohesion. They are brought about, for example, by very long-chain, highly entangled macromolecules and also by physically or chemically crosslinked macromolecules, and they permit the transmission of the forces engaging on an adhesive bond. Their result is that an adhesive bond is able to withstand sufficiently over a prolonged time period a long-term load acting on it, in the form for example of a sustained shearing load.

For more precise description and quantification of the extent of elastic and viscous components, and also of the proportion of the components to one another, the variables of storage modulus (G′) and loss modulus (G″) are employed, and can be determined by Dynamic Mechanical Analysis (DMA). G′ is a measure of the elastic fraction, G″ a measure of the viscous fraction, of a substance. Both variables are dependent on the deformation frequency and the temperature.

The variables can be determined by means of a rheometer. In this case, the material for analysis is exposed to a sinusoidally oscillating shearing stress in—for example—a plate/plate arrangement. In the case of instruments operating with shear stress control, measurements are made of the deformation as a function of time, and of the time offset of that deformation relative to the introduction of the shearing stress. This time offset is identified as phase angle 6.

The storage modulus G′ is defined as follows: G′=(τ/γ)·cos(δ) (i=shearing stress, γ=deformation, δ=phase angle=phase shift between shear stress vector and deformation vector). The definition of the loss modulus G″ is as follows: G″=(τ/γ)·sin(δ) (τ=shearing stress, γ=deformation, δ=phase angle=phase shift between shear stress vector and deformation vector).

A composition is considered in particular to be a PSA and is defined as such, in particular, for the purposes of the invention if at 23° C. in the deformation frequency range from 10⁰ to 10¹ rad/sec, both G′ and G″ are situated at least partly in the range from 10¹ to 10⁷ Pa. “Partly” means that at least a section of the G′ plot is within the window subtended by the deformation frequency range of from 10⁰ (inclusive) to 10¹ (inclusive) rad/sec (abscissa) and also the range of the G′ values from 10³ (inclusive) to 10⁷ (inclusive) Pa (ordinate) and when at least a section of the G″ plot is likewise within the corresponding window.

By a “poly(meth)acrylate” is meant a polymer whose monomer basis consists to an extent of at least 50 wt % of acrylic acid, methacrylic acid, acrylic esters and/or methacrylic esters, with acrylic esters and/or methacrylic esters being present at least proportionally, preferably at not less than 50 wt %, based on the overall monomer basis of the polymer in question. In particular a “poly(meth)acrylate” is a polymer obtainable by radical polymerization of acrylic and/or methylacrylic monomers and also, optionally, other copolymerizable monomers.

In accordance with the invention the content of (the) poly(meth)acrylate(s) is 40 to 70 wt %, based on the total weight of the PSA. The PSA preferably comprises 45 to 60 wt %, based on the total weight of the PSA of at least one poly(meth)acrylate.

The glass transition temperature of the inventively employable poly(meth)acrylates is preferably <0° C., more preferably between −20 and −50° C. The glass transition temperature of polymers or of polymer blocks in block copolymers is determined in the context of this invention by means of dynamic scanning calorimetry (DSC). For this, around 5 mg of an untreated polymer sample are weighed into an aluminum crucible (25 μL volume) and closed with a perforated lid. Measurement takes place using a DSC 204 F1 from Netzsch. For inertization, operation takes place under nitrogen. The sample is first cooled to −150° C., then heated up at a heating rate of 10 K/min to +150° C., and again cooled to −150° C. The subsequent second heating curve is run again at 10 K/min and the change in the heat capacity is recorded. Glass transitions are recognized as steps in the thermogram.

The glass transition temperature is obtained as follows (see FIG. 1):

the respectively linear portions of the measurement curve before and after the step are extended in the direction of rising (region before the step) and falling (region after the step) temperatures, respectively. In the region of the step, a balancing line 5 is placed parallel to the ordinate in such a way that it intersects the two lines of extension, specifically such as to form two areas 3 and 4 (between in each case one of the extension lines, the balancing lines, and the measurement curve) of equal content. The point of intersection of the balancing lines thus positioned with the measurement curve gives the glass transition temperature.

The poly(meth)acrylates of the PSA are preferably obtainable by at least proportional copolymerization of functional monomers which are preferably crosslinkable with epoxide groups. With particular preference these are monomers having acid groups (particularly carboxylic, sulfonic or phosphonic acid groups) and/or hydroxyl groups and/or acid anhydride groups and/or epoxide groups and/or amine groups; especially preferred are carboxyl-containing monomers. It is especially advantageous if the polyacrylate comprises copolymerized acrylic acid and/or methacrylic acid. All of these groups are crosslinkable with epoxide groups, so making the polyacrylate amenable advantageously to a thermal crosslinking with introduced epoxides.

Further monomers which can be used as comonomers for the poly(meth)acrylates, besides acrylic and/or methacrylic esters having up to 30 carbon atoms per molecule, are, for example, vinyl esters of carboxylic acids containing up to 20 carbon atoms, vinylaromatics having up to 20 carbon atoms, ethylenically unsaturated nitriles, vinyl halides, vinyl ethers of alcohols containing 1 to 10 carbon atoms, aliphatic hydrocarbons having 2 to 8 carbon atoms and having one or two double bonds, or mixtures of these monomers.

The properties of the poly(meth)acrylate in question may be influenced in particular by varying the glass transition temperature of the polymer, by means of the different weight proportions of the individual monomers. The poly(meth)acrylate(s) of the invention may preferably be traced back to the following monomer composition:
a) acrylic esters and/or methacrylic esters of the following formula

CH₂═C(R^{I})(COOR^{II})

where R^{I} is H or CH₃ and R^{II} is an alkyl radical having 4 to 14 carbon atoms,
b) olefinically unsaturated monomers having functional groups of the kind already defined for reactivity with preferably epoxide groups,
c) optionally further acrylates and/or methacrylates and/or olefinically unsaturated monomers which are copolymerizable with component (a).

The proportions of the corresponding components (a), (b) and (c) are preferably selected such that the polymerization product has a glass transition temperature of <0° C., more preferably between −20 and −50° C. (DSC). It is particularly advantageous to select the monomers of component (a) with a proportion of 45 to 99 wt %, the monomers of component (b) with a proportion of 1 to 15 wt % and the monomers of component (c) with a proportion of 0 to 40 wt % (the figures are based on the monomer mixture for the “base polymer”, i.e., without additions of possible additives to the completed polymer, such as resins etc.).

The monomers of component (a) are, in particular, plasticizing and/or apolar monomers. Preferred for use as monomers (a) are acrylic and methacrylic esters having alkyl groups consisting of 4 to 14 carbon atoms, more preferably 4 to 9 carbon atoms. Examples of such monomers are n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate and the branched isomers thereof such as, for example, isobutyl acrylate, isooctyl acrylate, isooctyl methacrylate, 2-ethylhexyl acrylate or 2-ethylhexyl methacrylate.

The monomers of component (b) are, in particular, olefinically unsaturated monomers having functional groups, especially having functional groups which are able to enter into a reaction with epoxide groups.

For component (b) it is preferred to use monomers having functional groups selected from the group encompassing the following: hydroxyl, carboxyl, sulfonic acid or phosphonic acid groups, acid anhydrides, epoxides, amines.

Particularly preferred examples of monomers of component (b) are acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, especially 2-hydroxyethyl acrylate, hydroxypropyl acrylate, especially 3-hydroxypropyl acrylate, hydroxybutyl acrylate, especially 4-hydroxybutyl acrylate, hydroxyhexyl acrylate, especially 6-hydroxyhexyl acrylate, hydroxyethyl methacrylate, especially 2-hydroxyethyl methacrylate, hydroxypropyl methacrylate, especially 3-hydroxypropyl methacrylate, hydroxybutyl methacrylate, especially 4-hydroxybutyl methacrylate, hydroxyhexyl methacrylate, especially 6-hydroxyhexyl methacrylate, allyl alcohol, glycidyl acrylate, glycidyl methacrylate.

In principle as component (c) it is possible to use all vinylically functionalized compounds which are copolymerizable with component (a) and/or with component (b). The monomers of component (c) may serve to adjust the properties of the resultant PSA.

Exemplary monomers of component (c) are as follows:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyl-adamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoro-ethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethyl-aminopropylacrylamide, dimethylaminopropylmethacrylamide, N-(1-methylundecyl)acrylamide, N-(n-butoxymethyl)acrylamide, N-(butoxymethyl)methacrylamide, N-(ethoxy-methyl)acrylamide, N-(n-octadecyl)acrylamide, additionally N,N-dialkyl-substituted amides, such as, for example, N,N-dimethylacrylamide, N,N-dimethylmethacrylamide, N-benzyl-acrylamide, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, vinyl isobutyl ether, vinyl esters, such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene. Macromonomers such as 2-polystyrene-ethyl methacrylate (weight average molecular weight M_{w}, determined by GPC of 4000 to 13 000 g/mol), poly(methyl methacrylate)-ethyl methacrylate (Mw of 2000 to 8000 g/mol).

Monomers of component (c) may advantageously also be chosen such that they contain functional groups which support subsequent radiation crosslinking (by electron beams or UV, for example). Suitable copolymerizable photoinitiators are, for example, benzoic acrylate and acrylate-functionalized benzophenone derivates. Monomers which support crosslinking by electron bombardment are, for example, tetrahydrofurfuryl acrylate, N-tert-butylacrylamide and allyl acrylate.

The preparation of polyacrylates (“polyacrylates” is understood in the context of the invention to be synonymous with “poly(meth)acrylates”) may take place by methods familiar to the skilled person, especially advantageously by conventional radical polymerizations or controlled radical polymerizations. The polyacrylates can be prepared by copolymerization of the monomeric components using the customary polymerization initiators and also, optionally, using chain transfer agents, with polymerization taking place at the usual temperatures in bulk, in emulsion, for example in water or liquid hydrocarbons, or in solution.

The polyacrylates are preferably prepared by polymerization of the monomers in solvents, more particularly in solvents having a boiling range of 50 to 150° C., preferably of 60 to 120° C., using the customary amounts of polymerization initiators, which are in general 0.01 to 5 wt %, more particularly 0.1 to 2 wt % (based on the total weight of the monomers).

Suitable in principle are all customary initiators familiar to the skilled person. Examples of radical sources are peroxides, hydroperoxides and azo compounds, as for example dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate, benzopinacol. One very preferred procedure uses 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont) as radical initiator.

Solvents suitable for preparing the poly(meth)acrylates include alcohols such as methanol, ethanol, n- and isopropanol, n- and isobutanol, preferably isopropanol and/or isobutanol, and also hydrocarbons such as toluene and, in particular, benzines of a boiling range from 60 to 120° C. Additionally it is possible to use ketones such as preferably acetone, methyl ethyl ketone, methyl isobutyl ketone, and esters such as ethyl acetate, and also mixtures of solvents of the type stated, preference being given to mixtures which include isopropanol, more particularly in amounts of 2 to 15 wt %, preferably 3 to 10 wt %, based on the solvent mixture used.

With preference, after the preparation (polymerization) of the polyacrylates, there is a concentration process, and the further processing of the polyacrylates is substantially solvent-free. The polymer can be concentrated in the absence of crosslinker and accelerator substances. It is also possible, however, for one of these classes of compound to be added to the polymer even prior to concentration, in which case the concentration takes place in the presence of this or these substance(s).

After the concentration step, the polymers can be transferred to a compounder. Concentration and compounding may optionally also take place in the same reactor.

The weight-average molecular weights M_{w} of the polyacrylates are preferably in a range from 20 000 to 2 000 000 g/mol, very preferably in a range from 100 000 to 1 500 000 g/mol, most preferably in a range from 150 000 to 1 000 000 g/mol. The figures for average molecular weight M_{W} and for polydispersity PD in this specification relate to the determination by gel permeation chromatography. It may be advantageous for this purpose to carry out polymerization in the presence of suitable chain transfer agents such as thiols, halogen compounds and/or alcohols in order to set the desired average molecular weight.

The figures for the number-average molar mass Mₙ and the weight-average molar mass M_{w} in this specification relate to the determination by gel permeation chromatography (GPC). The determination is made on 100 μl of a sample having undergone clarifying filtration (sample concentration 4 g/l). The eluent used is tetrahydrofuran with 0.1 vol % of trifluoroacetic acid. Measurement takes place at 25° C.

The precolumn used is a column of type PSS-SDV, 5 μm, 10³ Å, 8.0 mm*50 mm (details here and hereinafter in the following order: type, particle size, porosity, internal diameter*length; 1 Å=10⁻¹⁰ m). For separation a combination of the columns of type PSS-SDV, 5 μm, 10³ Å and also 10⁵ Å and 10⁶ Å each with 8.0 mm*300 mm is used (columns from Polymer Standards Service; detection by means of Shodex RI71 differential refractometer). The flow rate is 1.0 ml per minute. Calibration takes place against PMMA standards (polymethyl methacrylate calibration) in the case of polyacrylates and against PS standards (polystyrene calibration) otherwise (resins, elastomers).

The polyacrylates preferably have a K value of 30 to 90, more preferably of 40 to 70, as measured in toluene (1% strength solution, 21° C.). The K value of Fikentscher is a measure of the molecular weight and the viscosity of the polymer.

The principle of the method is based on the determination of the relative solution viscosity by capillary viscosimetry. For this purpose the substance under test is dissolved in toluene by shaking for thirty minutes to give a 1% strength solution. In a Vogel-Ossag viscosimeter at 25° C., the flow time is measured and is used to determine the relative viscosity of the sample solution in relation to the viscosity of the pure solvent. From tables it is possible according to Fikentscher [P. E. Hinkamp, Polymer, 1967, 8, 381] to read off the K value (K=1000 k).

Especially suitable in accordance with the invention are polyacrylates which have a narrow molecular weight distribution (polydispersity PD<4). In spite of a relatively low molecular weight, these compositions have a particularly good shear strength after crosslinking. Moreover, the lower polydispersity makes processing from the melt easier, since the flow viscosity is lower than that of a more broadly distributed polyacrylate, for largely the same application properties. Narrowly distributed poly(meth)acrylates may be prepared advantageously by anionic polymerization or by controlled radical polymerization methods, the latter being especially suitable. Via N-oxyls as well it is possible to prepare corresponding polyacrylates. Furthermore, Atom Transfer Radical Polymerization (ATRP) may be used advantageously for the synthesis of narrowly distributed polyacrylates, in which case the initiator used preferably comprises monofunctional or difunctional secondary or tertiary halides, with the halide or halides being abstracted using Cu-, Ni-, Fe-, Pd-, Pt-, Ru-, Os-, Rh-, Co-, Ir-, Ag- or Au complexes.

The monomers for preparing the poly(meth)acrylates preferably proportionally contain functional groups suitable for entering into linking reactions with epoxide groups. This has the advantageous effect of allowing the polyacrylates to be crosslinking thermally by reaction with epoxides. Linking reactions are, in particular, addition reactions and substitution reactions. Preferably, therefore, there is a linking of the building blocks carrying the functional groups to building blocks carrying epoxide groups, especially in the sense of a crosslinking of the polymer units carrying the functional groups, via crosslinker molecules carrying epoxide groups, as linking bridges. The substances containing epoxide groups are preferably polyfunctional epoxides, these being those having at least two epoxide groups; accordingly, there is preferably in total an indirect linking of the building blocks carrying the functional groups.

The poly(meth)acrylates of the PSA are crosslinked preferably by linking reactions—especially in the sense of addition or substitution reactions—of the functional groups they contain with thermal crosslinkers. All thermal crosslinkers can be used that both ensure a sufficiently long processing time, so that there is no gelling during the processing operation, especially the extrusion operation, and also lead to rapid post-crosslinking of the polymer to the desired degree of crosslinking at temperatures lower than the processing temperature, especially at room temperature. Possible for example is a combination of polymers containing carboxyl amine and/or hydroxyl groups with isocyanates, especially aliphatic or amine-deactivated trimerized isocyanates, as crosslinkers.

Suitable isocyanates are especially trimerized derivatives of MDI [4,4-methylenedi(phenyl isocyanate)], HDI [hexamethylene diisocyanate, 1,6-hexylene diisocyanate] and/or IPDI [isophorone diisocyanate, 5-isocyanato-1-isocyanatomethyl-1,3,3-trimethylcyclohexane], examples being the products Desmodur® N3600 and XP2410 (each BAYER AG: aliphatic polyisocyanates, low-viscosity HDI trimers). Likewise suitable is the surface-deactivated dispersion of micronized trimerized IPDI BUEJ 339®, now HF9 ® (BAYER AG).

Also suitable in principle for the crosslinking, however, are other isocyanates such as Desmodur VL 50 (MDI-based polyisocyanates, Bayer AG), Basonat F200WD (aliphatic polyisocyanate, BASF AG), Basonat HW100 (water-emulsifiable, polyfunctional, HDI-based isocyanate, BASF AG), Basonat HA 300 (allophanate-modified polyisocyanate based on isocyanurate, HDI-based, BASF) or Bayhydur VPLS2150/1 (hydrophilically modified IPDI, Bayer AG).

Preferred for use are thermal crosslinkers at 0.1 to 5 wt %, more particularly at 0.2 to 1 wt %, based on the total amount of the polymer to be crosslinked.

The poly(meth)acrylates of the PSA are crosslinked preferably by means of epoxide(s) or by means of one more substances containing epoxide groups. The substances containing epoxide groups are, in particular, polyfunctional epoxides, i.e., those having at least two epoxide groups; accordingly, the overall effect is that of indirect linking of those building blocks in the poly(meth)acrylates that carry the functional groups. The substances containing epoxide groups may be both aromatic and aliphatic compounds.

Outstanding suitable polyfunctional epoxides are oligomers of epichlorohydrin, epoxy ethers of polyhydric alcohols (especially ethylene, propylene and butylene glycols, polyglycols, thiodiglycols, glycerol, pentaerythritol, sorbitol, polyvinyl alcohol, polyallyl alcohol and the like), epoxy ethers of polyhydric phenols [especially resorcinol, hydroquinone, bis(4-hydroxy-phenyl)methane, bis(4-hydroxy-3-methylphenyl)methane, bis(4-hydroxy-3,5-dibromo-phenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis(4-hydroxyphenyl)phenylmethane, bis(4-hydroxyphenyl)phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl)-(4-chlorophenyl)methane, 1,1-bis(4-hydroxyphenyl)cyclohexane, bis(4-hydroxyphenyl)cyclohexylmethane, 4,4′-dihydroxybiphenyl, 2,2′-dihydroxybiphenyl, 4,4′-dihydroxydiphenyl sulfone] and also their hydroxyethyl ethers, phenol-formaldehyde condensation products, such as phenol alcohols, phenol-aldehyde resins and the like, S- and N-containing epoxides (for example, N,N-diglycidylaniline, N,N′-dimethyldiglycidyl-4,4-diaminodiphenylmethane), and also epoxides prepared by customary methods from polyunsaturated carboxylic acids or monounsaturated carboxylic acid residues of unsaturated alcohols, glycidyl esters, polyglycidyl esters, which may be obtained by polymerization or copolymerization of glycidyl esters of unsaturated acids, or are obtainable from other acidic compounds (cyanuric acid, diglycidyl sulfide, cyclic trimethylene trisulfone or derivatives thereof, and others).

Very suitable ethers are, for example, 1,4-butanediol diglycidyl ether, polyglycerol-3-glycidyl ether, cyclohexanedimethanol diglycidyl ether, glycerol triglycidyl ether, neopentyl glycol diglycidyl ether, pentaerythritol tetraglycidyl ether, 1,6-hexanediol diglycidyl ether), polypropylene glycol diglycidyl ether, trimethylolpropane triglycidyl ether, pentaerythritol tetraglycidyl ether, bisphenol A diglycidyl ether and bisphenol F diglycidyl ether.

Particularly preferred for the poly(meth)acrylates as polymers to be crosslinked is the use of a crosslinker-accelerator system (“crosslinking system”) described for example in EP 1 978 069 A1 in order to obtain better control over both the processing time, crosslinking kinetics and degree of crosslinking. The crosslinker-accelerator system comprises at least one substance containing epoxide groups, as crosslinker, and as accelerator at least one substance which has accelerating effect for crosslinking reactions by means of compounds containing epoxide groups, at a temperature below the melting temperature of the polymer to be crosslinked.

Accelerators used in accordance with the invention are more preferably amines (formally regarded as substitution products of ammonia; in the formulae below, said substituents are represented by “R” and in particular comprise alkyl and/or aryl radicals and/or other organic radicals), with more particular preference those amines which enter into no reactions or only minor reactions with the building blocks of the polymers that are to be crosslinked.

In principle, accelerators that can be selected are primary (NRH₂), secondary (NR₂H) or else tertiary (NR₃) amines, and of course also those having two or more primary and/or secondary and/or tertiary amine groups. Particularly preferred accelerators, however, are tertiary amines such as, for example, triethylamine, triethylenediamine, benzyldimethylamine, dimethylamino-methylphenol, 2,4,6-tris(N,N-dimethylaminomethyl)phenol, N,N′-bis(3-(dimethyl-amino)propyl)urea. Accelerators which can be used advantageously are also polyfunctional amines such as diamines, triamines and/or tetramines. Outstandingly suitable for example are diethylenetriamine, triethylenetetramine, trimethylhexamethylenediamine.

Further used as accelerators are preferably amino alcohols. Particular preference is given to using secondary and/or tertiary amino alcohols, and, in the case of two or more amine functionalities per molecule, preferably at least one, preferably all, of the amine functionalities are secondary and/or tertiary. As preferred amino alcohol accelerators it is possible to use triethanolamine, N,N-bis(2-hydroxypropyl)ethanolamine, N-methyldiethanolamine, N-ethyl-diethanolamine, 2-aminocyclohexanol, bis(2-hydroxycyclohexyl)methylamine, 2-(diiso-propylamino)ethanol, 2-(dibutylamino)ethanol, N-butyldiethanolamine, N-butylethanolamine, 2-[bis(2-hydroxyethyl)amino]-2-(hydroxymethyl)-1,3-propanediol, 1-[bis(2-hydroxyeth-yl)amino]-2-propanol, triisopropanolamine, 2-(dimethylamino)ethanol, 2-(diethyl-amino)ethanol, 2-(2-dimethylaminoethoxy)ethanol, N,N,N′-trimethyl-N′-hydroxyethyl bis-aminoethyl ether, N,N,N′-trimethylaminoethylethanolamine and/or N,N,N′-trimethylamino-propylethanolamine.

Further suitable accelerators are pyridine, imidazoles (such as, for example, 2-methylimidazole) and 1,8-diazabicyclo[5.4.0]undec-7-ene. Cycloaliphatic polyamines as well can be used as accelerators. Also suitable are phosphate based accelerators such as phosphines and/or phosphonium compounds such as, for example, triphenylphosphine or tetraphenylphosphonium tetraphenylborate.

The PSA further comprises at least one synthetic rubber. In accordance with the invention the synthetic rubber or rubbers are present in the PSA at 15 to 50 wt %, based on the total weight of the PSA. The PSA preferably comprises 20 to 40 wt % of at least one synthetic rubber, based on the total weight of the PSA.

Preferably at least one synthetic rubber in the PSA is a block copolymer having an A-B, A-B-A, (A-B)ₙ, (A-B)ₙX or (A-B-A)ₙX construction, in which
the blocks A independently of one another are a polymer formed by polymerization of at least one vinylaromatic;
the blocks B independently of one another are a polymer formed by polymerization of conjugated dienes having 4 to 18 C atoms and/or isobutylene, or are a partly or fully hydrogenated derivative of such a polymer;
X is the residue of a coupling reagent or initiator; and
n is an integer ≥2.

In particular all synthetic rubbers in the PSA are block copolymers having a construction as set out above. The PSA may therefore also comprise mixtures of different block copolymers having a construction as above.

Suitable block copolymers (vinylaromatic block copolymers) thus comprise one or more rubberlike blocks B (soft blocks) and one or more glasslike blocks A (hard blocks). More preferably at least one synthetic rubber in the PSA is a block copolymer having an A-B, A-B-A, (A-B)₃X or (A-B)₄X construction, where A, B and X are as defined above. Very preferably all synthetic rubbers in the PSA are block copolymers having an A-B, A-B-A, (A-B)₃X or (A-B)₄X construction, where A, B and X are as defined above. More particularly the synthetic rubber in the PSA is a mixture of block copolymers having an A-B, A-B-A, (A-B)₃X or (A-B)₄X construction which preferably comprises at least diblock copolymers A-B and/or triblock copolymers A-B-A.

Block A is generally a glasslike block having a preferred glass transition temperature (Tg, DSC) which is above room temperature. More preferably the Tg of the glasslike block is at least 40° C., more particularly at least 60° C., very preferably at least 80° C. and most preferably at least 100° C. The proportion of vinylaromatic blocks A in the overall block copolymers is preferably 10 to 40 wt %, more preferably 20 to 33 wt %. Vinylaromatics for the construction of block A include preferably styrene, α-methylstyrene and/or other styrene derivatives. Block A may therefore be a homopolymer or copolymer. More preferably block A is a polystyrene.

The vinylaromatic block copolymer additionally generally has a rubberlike block B or soft block having a preferred Tg of less than room temperature. The Tg of the soft block is more preferably less than 0° C., more particularly less than −10° C., as for example less than −40° C., and very preferably less than −60° C.

Preferred conjugated dienes as monomers for the soft block B are, in particular, selected from the group consisting of butadiene, isoprene, ethylbutadiene, phenylbutadiene, piperylene, pentadiene, hexadiene, ethylhexadiene, dimethylbutadiene and the farnesene isomers, and also any desired mixtures of these monomers. Block B as well may be a homopolymer or copolymer.

The conjugated dienes as monomers for the soft block B are more preferably selected from butadiene and isoprene. For example, the soft block B is a polyisoprene, a polybutadiene or a partly or fully hydrogenated derivative of one of these two polymers, such as polybutylenebutadiene in particular; or a polymer of a mixture of butadiene and isoprene. Very preferably the block B is a polybutadiene.

The PSA further comprises at least one tackifier which is compatible with the poly(meth)acrylate(s) and may also be referred to as peel adhesion booster or tackifying resin. A “tackifier” in line with the general understanding of the skilled person is an oligomeric or polymeric resin which raises the autoadhesion (the tack, the inherent stickiness) of the PSA in comparison to the otherwise identical PSA containing no tackifier.

A “tackifier compatible with the poly(meth)acrylate(s)” is a tackifier which alters the glass transition temperature of the system obtained after thorough mixing of poly(meth)acrylate and tackifier, in comparison to the pure poly(meth)acrylate, where even the mixture of poly(meth)acrylate and tackifier can only be assigned one Tg. In the system obtained after thorough mixing of poly(meth)acrylate and tackifier, a tackifier not compatible with the poly(meth)acrylate(s) would lead to two Tgs, one of them assignable to the poly(meth)acrylate and the other to the resin domains. The determination of the Tg in this context is calormetrically by DSC (differential scanning calorimetry).

The poly(meth)acrylate-compatible resins in the composition preferably have a DACP of less than 0° C., very preferably of at most −20° C., and/or preferably a MMAP of less than 40° C., very preferably of at most 20° C. Regarding the determination of DACP and MMAP, reference is made to C. Donker, PSTC Annual Technical Seminar, Proceedings, pages 149 to 164, May 2001.

MMAP is the mixed methylcyclohexane-aniline cloud point.

5.0 g of test substance (the tackifier resin specimen under investigation) are weighed out into a dry sample glass and admixed with 10 ml of dry aniline (CAS [62-53-3], ≥99.5%, Sigma-Aldrich #51788 or comparable) and 5 ml of dry methylcyclohexane (CAS [108-87-2], ≥99%, Sigma-Aldrich #300306 or comparable). The sample glass is shaken until the test substance has completely dissolved. For this purpose, the solution is heated to 100° C. The sample glass containing the resin solution is then introduced into a Chemotronic Cool cloud point instrument from Novomatics, in which it is heated to 110° C. Cooling takes place at a cooling rate of 1.0 K/min. The cloud point is detected optically. A recording is made for this purpose of the temperature at which the clouding of the solution amounts to 70%. The result is recorded in ° C. The lower the MMAP, the higher the aromaticity of the test substance.

DACP is the diacetone cloud point.

5.0 g of test substance (the tackifier resin specimen under investigation) are weighed out into a dry sample glass and admixed with 5.0 g of xylene (isomer mixture CAS [1330-20-7], ≥98.5%, Sigma-Aldrich #320579 or comparable). The test substance is dissolved at 130° C. and then cooled to 80° C. Any xylene that has escaped is made up of further xylene, to restore the 5.0 g of xylene. Then 5.0 g of diacetone alcohol (4-hydroxy-4-methyl-2-pentanone, CAS [123-42-2], 99%, Aldrich #H41544 or comparable) are added. The sample glass is shaken until the test substance has completely dissolved. For this purpose, the solution is heated to 100° C. The sample glass containing the resin solution is then introduced into a Chemotronic Cool cloud point instrument from Novomatics, in which it is heated to 110° C. Cooling takes place at a cooling rate of 1.0 K/min. The cloud point is detected optically. A recording is made for this purpose of the temperature at which the clouding of the solution amounts to 70%. The result is recorded in ° C. The lower the DACP, the higher the polarity of the test substance.

In accordance with the invention the tackifier compatible with the poly(meth)acrylates is preferably a terpene-phenolic resin or a rosin derivative, more preferably a terpene-phenolic resin. The PSA may also comprise mixtures of two or more tackifiers. Among the rosin derivatives, preference is given to rosin esters.

The PSA contains preferably 7 to 25 wt %, based on the total weight of the PSA, of at least one tackifier compatible with the poly(meth)acrylates. With particular preference the tackifier or tackifiers compatible with the poly(meth)acrylates is/are present at 12 to 20 wt %, based on the total weight of the PSA.

The tackifier or tackifiers in the PSA that is or are compatible with the poly(meth)acrylates is or are preferably also compatible or at least partly compatible with the synthetic rubber, more particularly with its soft block B, with the above definition of the term “compatible” being valid correspondingly. Polymer/resin compatibility is dependent on factors including the molar mass of the polymers or resins. The compatibility is better when the molar mass(s) are lower. For a given polymer it may be possible for the low molecular mass constituents of the resin molar mass distribution to be compatible with the polymer, but not those of higher molecular mass. This is an example of partial compatibility.

The weight ratio of poly(meth)acrylates to synthetic rubbers in the PSA is preferably from 1:1 to 3:1, especially from 1.8:1 to 2.2:1.

The weight ratio of tackifiers compatible with the poly(meth)acrylates to synthetic rubbers in the PSA is preferably not more than 2:1, especially not more than 1:1. This weight ratio amounts at least to preferably 1:4.

In accordance with the invention the synthetic rubber in the PSA is in dispersion in the poly(meth)acrylate.

Preferably the synthetic rubber in the PSA is in dispersion in the poly(meth)acrylate. Accordingly, poly(meth)acrylate and synthetic rubber are preferably each homogeneous phases. The poly(meth)acrylates and synthetic rubbers present in the PSA are preferably chosen such that at 23° C. they are not miscible with one another to the point of homogeneity. At least microscopically and at least at room temperature, therefore, the PSA preferably has at least two-phase morphology. More preferably, poly(meth)acrylate(s) and synthetic rubber(s) are not homogeneously miscible with one another in a temperature range from 0° C. to 50° C., more preferably from −30° C. to 80° C., and so in these temperature ranges the PSA at least microscopically is in at least two-phase form.

Components are defined for the purposes of this specification as “not homogeneously miscible with one another” when even after intense mixing, the formation of at least two stable phases is detectable physically and/or chemically, at least microscopically, with one phase being rich in one component and the second phase being rich in the other component. The presence of negligibly small amounts of one component in the other, without opposing the development of the multiphase character, is considered insignificant in this regard. Hence the poly(meth)acrylate phase may contain small amounts of synthetic rubber, and/or the synthetic rubber phase may contain small amounts of poly(meth)acrylate components, as long as these amounts are not substantial amounts which influence phase separation.

Phase separation may be realized in particular such that discrete regions (“domains”) which are rich in synthetic rubber—in other words are essentially formed of synthetic rubber—are present in a continuous matrix which is rich in poly(meth)acrylate—in other words is essentially formed of poly(meth)acrylate. One suitable system of analysis for a phase separation is scanning electron microscopy, for example. Alternatively, phase separation can also be detectable, for example, by the different phases having two glass transition temperatures independent of one another in dynamic scanning calorimetry (DSC). Phase separation is present according to the invention when it can clearly be shown by at least one of the analytical methods.

Additional multiphase character may also be present as a fine structure within the synthetic rubber-rich domains, with the A blocks forming one phase and the B blocks forming a second phase.

The layer of PSA used takes the form preferably of adhesive tape.

An adhesive tape is understood here to be an external form whose one dimension, the thickness, is significantly smaller than the two other dimensions, the width and length.

A profile is understood here in particular to be a strand of plastic drawn as an extrusion process. Within the strand of plastic, various supports, such as adhesion-coated metal tapes or glass filaments, may be enveloped by the liquid plastics melt. Profile materials used are preferably polypropylene (PP), polyethylene (PE), a blend of acrylonitrile-butadiene-styrene (ABS) and polyvinyl chloride (PVC), and various thermoplastic elastomers such as TPV (PP and EPDM) and TPS (SEBSplusPP).

In the case of the PP/EPDM profiles used, excessive surface tensions obtained as a result of plasma treatment may be accompanied by an observed deterioration in the fracture mode after heat, especially after humidity/heat processing. This phenomena, known per se, is attributable to overtreatment of the PP/EPDM profile surface; the overtreatment produces, on the PP/EPDM surface, what are called “low-molecular-weight oxidized materials”, LMWOMs, which lie on the profile surface and are no longer covalently bonded to the rest of the profile matrix. LMWOMs are readily water-soluble and hence promote the moisture undermining of the interface after bonding. It has emerged that in the case of PP/EPDM profile surfaces, a surface tension of 44 to 56 mN/m, particularly after humidity/heat storage, generates more favorable—that is, higher—peel adhesion forces on the above-described first adhesive side of the adhesive tape than lower profile surfaces, in other words undertreated, or else stronger profile surfaces, meaning overtreated profile surfaces. Plasma treatment is particularly favorable if the surface tension of the PP/EPDM profile surface is between 50 to 56 mN/m.

The PSA is preferably foamed. Foaming may be accomplished by any desired chemical and/or physical methods. Preferably, however, a foamed PSA is obtained by the introduction and subsequent expansion of microballoons. “Microballoons” are understood to be elastic hollow microspheres which are therefore expandable in their basic state and have a thermoplastic polymer shell. These spheres are filled with low-boiling liquids or liquefied gas. Shell materials used are, in particular, polyacrylonitrile, PVDC, PVC or polyacrylates. Particularly suitable as a low-boiling liquid are hydrocarbons of the lower alkanes, for example isobutane or isopentane, which are enclosed in the form of liquefied gas under pressure in the polymer shell.

Physical exposure of the microballoons, through exposure to heat, for example, particularly by supply of heat or generation of heat, brought about for example by ultrasound or by microwave radiation, has the effect on the one hand of softening of the outer polymer shell, and at the same time the propellant gas in liquid form within the shell undergoes transition to its gaseous state. Given a defined pairing of pressure and temperature, also referred to as the critical pairing, the microballoons stretch out irreversibly and undergo three-dimensional expansion. Expansion is at an end when the internal and external pressures match one another. Since the polymeric shell is retained, the result is a closed-cell foam.

Where foaming takes place using microballoons, the microballoons may be supplied as a batch, a paste or an unextended or extended powder to the formulation. Metering points are conceivable, for example, before or after the point of addition of the poly(meth)acrylate—for instance together as a powder with the synthetic rubber or as a paste at a later point in time.

A multiplicity of types of microballoon is available commercially, these types differing essentially in their size (6 to 45 μm in diameter in the unexpanded state) and in the onset temperatures they require for expansion (75 to 220° C.). One example of commercially available microballoons are the Expancel® DU products (DU=dry unexpanded) from Akzo Nobel.

Unexpanded microballoon products are also available in the form of an aqueous dispersion with a solids fraction or microballoon fraction of around 40 to 45 wt %, and additionally as polymer-bound microballoons (masterbatches), for example in ethyl-vinyl acetate with a microballoon concentration of around 65 wt %.

Furthermore, microballoon slurry systems are available, in which the microballoons are present as an aqueous dispersion with a solids fraction of 60 to 80 wt %.

The microballoon dispersions, the microballoon slurries, and the masterbatches, like the DU products, are suitable for producing a foamed PSA.

A foamed PSA may also be generated using what are called preexpanded microballoons. With this group, the expansion takes place prior to incorporation into the polymer matrix.

Preexpanded microballoons are commercially available, for example, under the Dualite® designation or with the product designation DE (dry expanded).

The density of a foamed PSA is preferably 200 to 1000 kg/m³, more preferably 300 to 900 kg/m³, especially 400 to 800 kg/m³.

With particular preference the polymer foam comprises microballoons which in the unexpanded state at 25° C. have a diameter of 3 μm to 40 μm, especially of 5 μm to 20 μm, and/or which after expansion have a diameter of 10 μm to 200 μm, especially of 15 μm to 90 μm.

The polymer foam preferably contains up to 30 wt % of the microballoons, in particular between 0.5 wt % and 10 wt %, based in each case on the total mass of the polymer foam.

“Expandable” microballoons are understood to refer not only to completely unexpanded microballoons, but also to microballoons which, though having already undergone partial expansion, can be expanded still further.

The proportion of the microballoons in a given volume of the PSA is determined by computer tomography (CT). Operation took place in particular with a high-resolution x-ray microtomograph. Computer tomography allows a clear distinction to be made between gas (pores generated by the microballoons) and solid (adhesive matrix), which can also be shown outstandingly in graphic form. By evaluation with suitable analysis and visualization software, the volume fraction of the microballoons in the volume under consideration can be determined precisely.

The adhesive tapes are, in particular, those of the ACX^{plus} range from tesa SE, currently available for example under the brand name “ACX^{plus}7812”.

Adhesive tapes of this kind comprise a carrier layer also referred to as the hard phase. The polymer basis of the hard phase is preferably selected from the group consisting of polyvinyl chlorides (PVC), polyethylene terephthalates (PET), polyurethanes, polyolefins, polybutylene terephthalates (PBT), polycarbonates, polymethyl methacrylates (PMMA), polyvinyl butyrals (PVB), ionomers, and mixtures of two or more of the above-recited polymers. The polymer basis of the hard phase is more preferably selected from the group consisting of polyvinyl chlorides, polyethylene terephthalates, polyurethanes, polyolefins, and mixtures of two or more of the above-recited polymers. The hard phase is essentially a polymer film whose polymer basis is selected from the materials above. A “polymer film” is a thin, sheetlike, flexible, windable web whose material basis is formed essentially by one or more polymers.

“Polyurethanes” are understood in the broad sense to be polymeric substances in which repeating units are linked to one another by urethane moieties —NH—CO—O—.

“Polyolefins” are polymers which in terms of amount of substance contain repeating units of the general structure —[—CH2-CR1R2-]n- to an extent of at least 50%, where R1 is a hydrogen atom and R2 is a hydrogen atom or is a linear or branched, saturated aliphatic or cycloaliphatic group. Where the polymer basis of the hard phase comprises polyolefins, they are more preferably polyethylenes, especially polyethylenes of ultrahigh molar mass (UHMWPE).

The “polymer basis” means the polymer or polymers accounting for the largest weight fraction of all the polymers present in the relevant layer or phase.

The thickness of the hard phase is especially ≤150 μm. The thickness of the hard phase is preferably 10 to 150 μm, more preferably 30 to 120 μm, and especially 50 to 100 μm, for example 70 to 85 μm. The “thickness” refers to the extent of the layer or phase in question along the z-ordinate of an imaginary coordinate system in which the x-y plane is formed by the plane generated by the machine direction and the direction transverse to the machine direction.

The thickness is determined by measurement at at least five different locations of the relevant layer or phase, and subsequent formation of the arithmetic mean from the measurement results obtained. The thickness of the hard phase here is measured in accordance with DIN EN ISO 4593.

Adhesive tapes of these kinds may also have a soft phase, comprising a polymer foam, a viscoelastic composition and/or an elastomeric composition. The polymer basis of the soft phase is preferably selected from polyolefins, polyacrylates, polyurethanes, and mixtures of two or more of the above-recited polymers.

In the simplest variant the adhesive tape consists only of a soft phase.

A “polymer foam” refers to a structure of gas-filled spherical or polyhedral cells which are bounded by liquid, semiliquid, highly viscous or solid cell walls; additionally, the main constituent of the cell walls is a polymer or a mixture of two or more polymers.

A “viscoelastic composition” refers to a material which displays features not only of pure elasticity (reversion to the initial state after external mechanical exposure) but also features of a viscous liquid—for example, the incidence of internal friction on deformation. In particular, polymer-based PSAs are regarded as viscoelastic compositions.

An “elastomeric composition” refers to a material which has rubber-elastic behavior and at 20° C. can be extended repeatedly to at least twice its length and, once the force required for extension is removed, immediately again approximately assumes its original dimension.

The understanding of the terms “polymer basis”, “polyurethanes”, and “polyolefins” is subject to the statements made above

The polymer basis of the soft phase is more preferably selected from polyolefins, polyacrylates, and mixtures of two or more of the aforementioned polymers. Where polyolefins form part of the polymer basis of the soft phase, they are preferably selected from polyethylenes, ethylene-vinyl acetate copolymers (EVA), and mixtures of polyethylenes and ethylene-vinyl acetate copolymers (PE/EVA blends). These polyethylenes may be of various polyethylene types, examples being HDPE, LDPE, LLDPE, blends of these polyethylene types, and/or mixtures thereof.

In one embodiment, the soft phase comprises a foam and a pressure-sensitive adhesive layer, composed of the PSA of the invention, arranged respectively above and below the foamed layer, with the polymer basis of the foam consisting of one or more polyolefins. With particular preference the polymer basis of the foam here consists of one or more polyethylenes, ethylene-vinyl acetate copolymers, and mixtures of one or more polyethylenes and/or ethylene-vinyl acetate copolymers. Very preferably the polymer basis of the foam here consists of one or more polyethylenes.

The polyolefin-based foam itself has only very little pressure-sensitive adhesiveness, or none. The bond with the hard phase or with the substrate is therefore brought about advantageously through the pressure sensitive adhesive layers. The foaming of the polyolefin-based starting material of the foam is brought about preferably by added blowing gas in a physical foaming process, and/or by means of a chemical foaming agent, as for example by azodicarbonamide.

In another embodiment, the soft phase is a pressure-sensitively adhesive polymer foam composed of the PSA of the invention. “Pressure-sensitively adhesive foam” means that the foam itself is a PSA and there is therefore no need for an additional pressure-sensitive adhesive layer to be applied. This is advantageous because in the production operation there are fewer layers to be assembled and the risk of detachment phenomena and of other unwanted phenomena at the layer boundaries is reduced.

It is also possible that the polymer foam that per se has the property of pressure-sensitive adhesion has been coated on its upper and/or lower side with a PSA composition, where the polymer basis of said PSA composition is preferably composed of polyacrylates. Alternatively, it is possible to laminate, to the foamed layer, other adhesive layers and/or differently pretreated adhesive layers, i.e. by way of example pressure-sensitive adhesive layers and/or heat-activatable layers based on polymers other than poly(meth)acrylates. Suitable basis polymers are natural rubbers, synthetic rubbers, acrylate block copolymers, vinylaromatic block copolymers, in particular styrene block copolymers, EVA, polyolefins, polyurethanes, polyvinyl ethers and silicones. It is preferable that said layers comprise no significant content of constituents that can migrate and whose compatibility with the material of the foamed layer is sufficiently good that significant amounts of these diffuse into the foamed layer and alter its properties.

The soft phase of the adhesive tape can comprise one or more fillers. The filler(s) can be present in one or more layers of the soft phase.

Preferably the soft phase comprises a polymer foam, and the polymer foam comprises partially or fully expanded microballoons.

The polymer foam of the soft phase of the adhesive tape—to the extent that this phase comprises a polymer foam—is preferably characterized by the substantial absence of open-cell cavities. It is particularly preferable that the proportion of cavities without their own polymer shell, i.e. of open cell caverns, is not more than 2% by volume in the polymer foam, in particular not more than 0.5% by volume. The polymer foam is therefore preferably a closed-cell foam.

The soft phase of the adhesive tape can also optionally comprise pulverulent and/or granular fillers, dyes and pigments, and in particular also abrasive and reinforcing fillers, such as chalks (CaCO3), titanium dioxides, zinc oxides and carbon blacks, inclusive of high proportions thereof, i.e. from 0.1 to 50 wt %, based on the total mass of the soft phase.

Other materials that can be present in the soft phase are low-flammability fillers, such as ammonium polyphosphate; electrically conductive fillers, such as conductive carbon black, carbon fibers and/or silver-coated beads; thermally conductive materials, such as boron nitride, aluminum oxide, silicon carbide; ferromagnetic additives, such as iron(III) oxides; other additives to increase volume, for example expandants, solid glass beads, hollow glass beads, carbonized microbeads, hollow phenolic microbeads, microbeads made of other materials; silica, silicates, organically renewable raw materials, such as wood flour, organic and/or inorganic nanoparticles, fibers; aging inhibitors, light stabilizers, antiozonants and/or compounding agents. Aging inhibitors that can be used are preferably either primary aging inhibitors, e.g. 4-methoxyphenol or Irganox® 1076, or else secondary aging inhibitors, e.g. Irgafos® TNPP or Irgafos® 168 from BASF, optionally also in combination with one another. Other aging inhibitors that can be used are phenothiazine (C-radical scavenger), and also hydroquinone methyl ether in the presence of oxygen, and also oxygen itself.

The thickness of the soft phase is preferably 200 to 1800 μm, particularly preferably 300 to 1500 μm, in particular 400 to 1000 μm. The thickness of the soft phase is determined in accordance with ISO 1923.

The bonding of hard and soft phase, or else of layers provided in the soft and/or hard phase, to one another to give the adhesive tape can be achieved by way of example via lamination or coextrusion. There can be direct, i.e. unmediated, bonding between the hard and soft phase. It is equally possible that the arrangement has one or more adhesion-promoting layers between hard and soft phase. The adhesive tape can moreover comprise other layers.

It is preferable that at least one of the layers to be bonded to one another has been pretreated by corona-pretreatment methods (using air or nitrogen), plasma-pretreatment methods (air, nitrogen or other reactive gases, or reactive compounds that can be used in the form of aerosol), or flame-pretreatment methods, and it is more preferable that a plurality of the layers to be bonded to one another have been thus pretreated, and it is very particularly preferable that all of the layers to be bonded to one another have been thus pretreated.

On the reverse side of the hard phase, i.e. on the side facing away from the substrate, there is preferably a functional layer applied which by way of example has release properties or UV-stabilizing properties. Said functional layer is preferably composed of a film of thickness ≤20 μm, particularly preferably ≤10 μm, in particular ≤8 μm, for example ≤5 μm, or of a coating material of thickness ≤10 μm, particularly preferably ≤6 μm, in particular ≤3 μm, for example ≤1.5 μm. Both the film and the coating material preferably comprise a UV absorber, and/or the polymer basis of the film or of the coating material comprises UV-absorbing and/or UV-deflecting groups.

Films can be applied to the reverse side of the hard phase via lamination or coextrusion. The film preferably involves a metalized foil. The polymer basis of the film is preferably selected from the group consisting of polyarylenes, polyvinyl chlorides (PVC), polyethylene terephthalates (PET), polyurethanes, polyolefins, polybutylene terephthalates (PBT), polycarbonates, polymethyl methacrylates (PMMA), polyvinyl butyrals (PVB), ionomers and mixtures of two or more of the polymers listed above. The expression “main constituent” here means “constituent with the greatest proportion by weight, based on the total weight of the film”. It is preferable that, with the exception of the polyarylenes, all of the materials listed for the film have a high content of UV stabilizers.

In one specific embodiment, the adhesive tape is composed, in the sequence directed toward the substrate, of a functional layer (as described above); of a hard phase and of a soft phase composed of a pressure-sensitive adhesive layer of the PSA of the invention, of a polymer foam, the polymer basis of which is composed of one or more polyolefins, and of another pressure-sensitive adhesive layer of the PSA of the invention. The lower pressure-sensitive adhesive layer can have protective covering by a release liner which is not however considered to be part of the adhesive tape.

The adhesive tapes preferably comprise foamed compositions, more particularly of the type described above, which may additionally have a (or two or more) intermediate carrier(s).

### BRIEF DESCRIPTION OF THE DRAWINGS

The invention is described by means of three exemplary embodiments, in which:

FIG. 1 shows a heat flow/temperature graph for determining the glass transition temperature,

FIG. 2 shows a schematic product construction made up of profile, ACX^{plus}7812 adhesive tape and LSE substrate surface,

FIGS. 3a, 3b show a PP/EPDM profile surface with LMWOMs after a plasma overtreatment, and

FIG. 4 shows the results of a comparative experiment between untreated and treated samples.

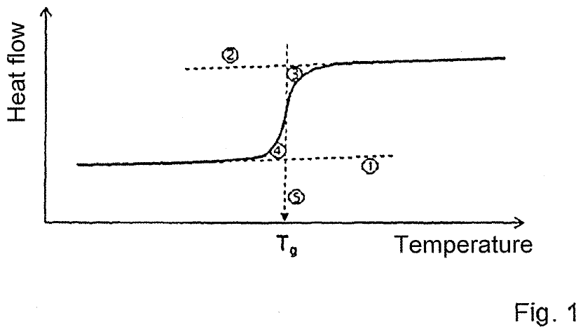

### DETAILED DESCRIPTION

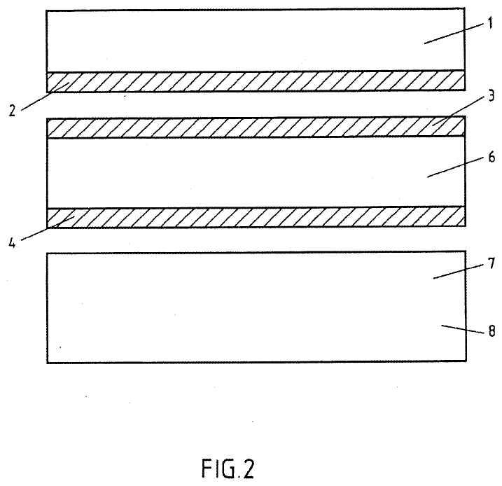

With reference to FIG. 2, Tesa® ACXplus 7812 is an acrylate foam adhesive tape for bonding of exterior mounted components.

The composition of Tesa® ACXplus 7812 is typically as follows:

| | | |
|---|---|---|
| Polymethacylate | 49 | wt % |
| Kraton D 1118* | 29 | wt % |
| Microballons 920 DU40 | 4 | wt % |
| Dertophene DT 105** | 18 | wt % |

*Kraton D 1118 styrene-butadiene-styrene 76 wt % diblock, block polystyrene content: 31 wt %, Kraton polymers (molecular weight Mw of the 3-block fraction of 150 000 g/mol)
**Dertophene DT 105 terpene-phenolic resin

A profile surface 2 of a profile 1, and also first and second adhesive sides 3, 4 of an adhesive tape 6, were plasma-treated using a plasma apparatus from the manufacturer Plasmatreat with the designation “Openair-plasma”.

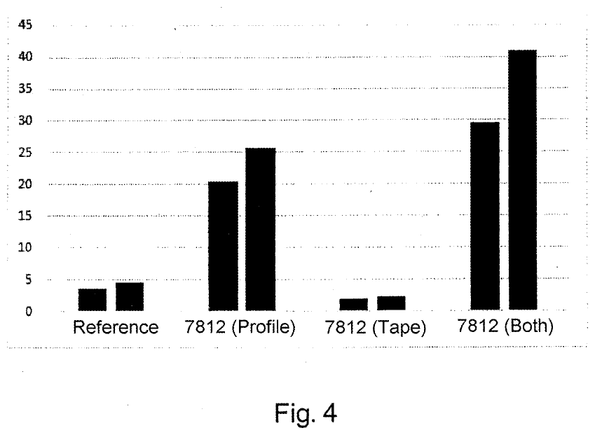

Using the plasma apparatus, in a simultaneous plasma treatment of the profile surface 2 of PP and EPDM and the first adhesive side 3 of the ACX^{plus}7812 adhesive tape 6, four tests were carried out to show the increase in peel adhesion on simultaneous treatment of both interfaces, by comparison with nontreatment or, respectively, with treatment of only one of the two interfaces. The results of the measurements are set out in FIG. 4, the peel adhesion being determined in each case after 20 minutes and 24 hours.

It is clearly apparent that there is an increase in peel adhesion between the profile surface 2 and the first adhesive side 3 of the ACX^{plus}7812 adhesive tape 6, relative to the reference bond, when both interfaces are plasma-treated. In the case of the reference bond, neither of the two reference faces is plasma-treated.

An increase in peel adhesion in fact occurs not only with PP and EPDM profiles, but instead with virtually all plastics profiles, relative to the ACX^{plus}7812 adhesive tape 6, when both interfaces have been plasma-treated.

In addition, the tests were undertaken to verify manufacturer recommendations for the plasma activation of the PP/EPDM profile surfaces 2; here it emerged that the plasma parameters frequently delivered by the manufacturers to the user are not suitable, since almost universally the maximum possible surface tension on the profiles 1 is desired, since it is associated with the anticipated improvement in peel adhesion. This, however, did not prove to be correct.

The fabrication trial described below was carried out using an OPENAIR plasma rotation unit (system: RD1004, FG5001) from Plasmatreat, Steinhagen/Germany. The nozzle attachment used possesses a diameter of 10 mm and an exit angle of 5° (Art. PTF 2646).

In the trial, a treatment speed of 6 m/min was chosen, and the nozzle distance was reduced in four steps from 20 to 14 mm (see tab. 1). After the treatment, the surface tension was measured using test inks.

TABLE 1
Measurement of the surface tension
with different plasma parameters

| | Treatment speed | Treatment distance | Surface tension |
|---|---|---|---|
| Trial | [m/min] | [mm] | [mN/m] |
| 1 | 6 | 20 | 44 |
| 2 | 6 | 18 | 50 |
| 3 | 6 | 16 | 56 |
| 4 | 6 | 14 | 66 |

The profiles 1 produced were cut into test units 150 mm in size, and their peel strength (90°-T-peel) was determined on a Zwick tensile testing machine.

The PP/PDM (Moplen EP1006, LyondellBasell) profiles furnished with ACX^{P}US adhesive tape 6 and pretreated were investigated for their fracture mode (see tab. 2) in accordance with the Volkswagen group standard TL 52018-F “foam adhesive tape double-sided”. after
as-supplied state (→3d RT),
hot storage (→storage for 240 h at +90° C.; 24 h acclimatization under standard conditions), and
heat-plus-humidity storage (→storage for 240 h at +40° C. and 10000 relative humidity; storage is followed by drying at +70° C. in a forced air drying cabinet with fresh air supply—duration 8 h; 24 h acclimatization under standard conditions).

TABLE 2
Fracture modes after storage (VW TL 52018)

| | Fracture aspect after . . . | | |
|---|---|---|---|
| | | | Heat-plus-humidity |
| Surface | As-supplied | Hot storage | storage 240 h +40° C. |
| tension | state | 240 h +90° C., | 100% rel. hum., |
| [mN/m] | (3d RT) | acclimatization | acclimatization |
| 44 | Adhesive | cohesive (some mixed | cohesive (some mixed |
| | | fracture) | fracture) |
| 50 | adhesive | cohesive (primarily) | cohesive (some mixed |
| | | | fracture) |
| 56 | adhesive | cohesive (some mixed | adhesive (primarily) |
| | | fracture) | |
| 66 | adhesive | adhesive | adhesive |

This result scenario shows that in the case of the high surface tensions, a deterioration is found in the fracture aspect after hot storage and particularly after hot-and-humid storage.

The known phenomena is attributable to an overtreatment of the PP/EPDM profile surface 2. The highly oxidized “polymer debris” LMWOM, produced as a result of unfavorable parameters, lies on the polymer surface and is no longer joined covalently to the bulk of the polymer matrix. LMWOM is highly water-soluble and so promotes the rearward migration of moisture into the interfaces.

As shown by the fracture aspect according to table 2, overtreated profile surfaces 2 can dramatically impair the resistance to heat plus humidity. The heat resistance in the combination of materials described above may be influenced by overtreatment, and heat/humidity storage may even cause bonds which, under standard conditions, undergo adhesive fracture to suffer cohesive fracture.

Even after the above-stated reconditioning, the damage to the adhesive bond can no longer be “healed”.

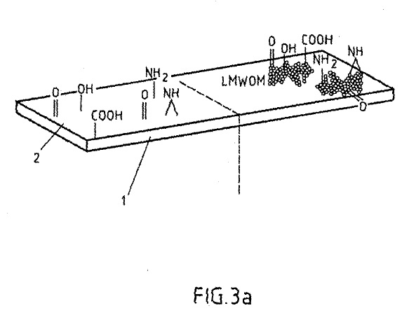

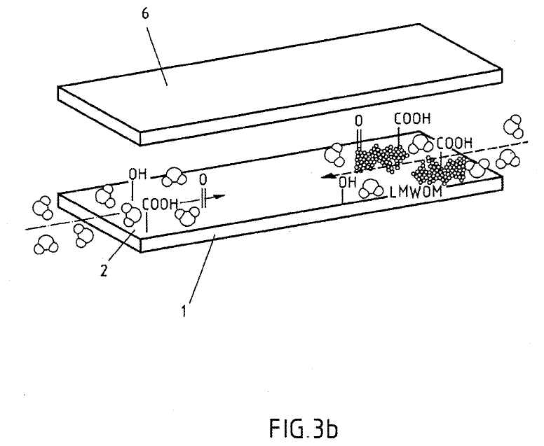

The LMWOMs have a particularly strong effect on the hydrophilic test liquids, thereby distorting the measurement of the surface tension. Functional groups which are covalently bonded on the pretreated polymer matrix are not brought into solution and, moreover, produce different contact angles relative to overtreated surfaces. In analytical terms, the functionalization on the profile surface 2 with the functionalized LMWOMs is identical (see FIGS. 3a, 3b). Differentiation is possible only with difficulty.

It has now emerged that in the plasma treatment of the opposite, second adhesive side 4 of the adhesive tape 6 in the form of a pressure-sensitive adhesive tape, there is a marked increase in peel adhesion on LSE substrates as LSE substrate surfaces 7, even when only the second adhesive side 4 of the adhesive tape 6 is plasma-treated and not the LSE substrate surface 7. This, of course, leads to a considerable facilitation of the bonding process, since the bulky LSE substrate surface 7, for example the LSE substrate surface 7 of a substrate 8 such as a vehicle door, for example, of a part of a vehicle panel, etc. need no longer be pretreated with a plasma apparatus. With regard to the adhesive bonding of plasma-treated PSA layers, such as ACX^{plus}7812, for example, and an LSE substrate surface 7, reference is also made to DE 10 2016 224 684 A1, in which corresponding series of experiments were carried out. In accordance with the invention, however, it has now emerged that through the use of the ACX^{plus}7812 adhesive tape 6, in other words of an acrylate adhesive tape, the adhesive bonding of virtually all profiles 1 to LSE substrate surfaces 7 is possible, and the LSE substrate surface 7 does not need to be plasma-treated, but instead only the second adhesive layer 4 of the ACX^{plus}7812 adhesive tape 6, which, however, functions as a mediator, as a kind of adhesive promoter, between the LSE substrate surface 7 and the profile surface 2.

### LIST OF REFERENCE NUMERALS

1 Profile
2 Profile surface
3 First adhesive side
4 Second adhesive side
6 Adhesive tape
7 LSE substrate surface
8 Substrate

1. A method for adhesively bonding profiles to substrate surfaces, the method comprising:
plasma-treating each of a profile surface and a first adhesive side of a layer of pressure sensitive adhesive, the pressure sensitive adhesive comprising:
a) 40 to 70 wt %, based on the total weight of the pressure sensitive adhesive, of at least one poly(meth)acrylate;
b) 15 to 50 wt %, based on the total weight of the pressure sensitive adhesive, of at least one synthetic rubber; and
c) at least one tackifier compatible with the poly(meth)acrylate(s) bonding the profile surface and the first adhesive side to one another,
plasma-treating a second adhesive side of the layer of the pressure sensitive adhesive, and
bonding the plasma-treated second adhesive side to the substrate surface.

2. The method of claim 1, wherein the substrate surface is a low surface energy (LSE) substrate surface and the plasma-treated second adhesive side is adhered to the LSE substrate surface; wherein a low energy surface substrate has a surface energy of 38 mN/m or less.

3. The method of claim 1, wherein an adhesive tape is used as the layer of pressure sensitive adhesive.

4. The method of claim 1, wherein the profile surface and the first adhesive side are plasma-treated simultaneously.

5. The method of claim 1, wherein the substrate surface is not plasma-treated and the plasma-treated second adhesive side is bonded to the non-plasma-treated substrate surface.

6. The method of claim 1, wherein the profile surface comprises a material selected from the group consisting of polypropylene, polyethylene, a blend of acrylonitrile-butadiene-styrene and polyvinyl chloride, a thermoplastic vulcanizate, a styrenic block copolymer, and any combination thereof.
